(19) United States
(12) Patent Application Publication
(10) Pub. No.: US 2011/0267612 A1
(43) Pub. Date: Nov. 3, 2011

(54) Hollow Core Photonic Crystal Fibre Comprising a Fibre Grating in the Cladding and Its Applications

(75) Inventors: Peter John Roberts, Oxford (GB); Abdel Fetah Benabid, Bath (GB)

(73) Assignee: University of Bath, Bath (GB)

(21) Appl. No.: 13/002,390

(22) PCT Filed: Jul. 3, 2009
(86) PCT No.: PCT/GB2009/001666

§ 371 Date: Apr. 19, 2011

(30) Foreign Application Priority Data
Jul. 4, 2008 (GB) 0812319.2

(51) Int. Cl. G01J 3/44; G06F 17/50; G02B 6/028

(52) U.S. Cl. 356/301; 385/124; 703/1

(57) ABSTRACT

An optical fibre is provided having a fibre cladding around a longitudinally extending optical propagation core. The cladding has a reflection region of a varying refractive index in the longitudinal direction.

This invention relates to an optical fibre and method.

### BACKGROUND SECTION

Hollow Core Photonic Crystal Fibres (HC-PCF), also known as a band-gap fibres, air-guiding band-gap fibres, or microstructured fibres, are well known in the industry and have been the object of an ever growing interest over the past decade. Known applications of HC-PCF span from telecoms and metrology to gas-laser systems, as described for example in “Stimulated Raman Scattering in Hydrogen-Filled Hollow-Core Photonic Crystal Fibre,” by F. Benabid, J. C. Knight, G. Antonopoulos, and P. S. J. Russell, Science 298, 399-402 (2002) (“Benabid et al”) or in “Hollow-core photonic bandgap fibre: new light guidance for new science and technology”, by F. Benabid, Philos. Trans. R. Soc. A-Math. Phys. Eng. Sci. 364 (2006) 3439-3462.

The basic structure of a HC-PCF is shown in FIG. 1 and will be familiar to the skilled reader. The fibre 100 includes a hollow core 102 surrounded by a cladding 104 of silica microcapillaries. The cladding creates a photonic band gap (PBG) that acts to trap light in the core and hence act as a special optical fibre (waveguide) with the unique ability of guiding light in an empty core. Physically, a HC-PCF is usually a fibre whose outer-diameter is around 125-200 μm and whose core diameter ranges from 5 μm to 20 μm, although in principle there is no upper limit to the diameter. The thickness of the silica web of microcapillaries is typically only a few 100 nanometres (typically: 100 nm-500 nm) for a low-loss guidance.

HC-PCF enable transportation of tightly focused laser beams without the constraints of diffraction. This is because the guidance in HC-PCF is not achieved via total internal reflection but through the trapping of light in the x-y plane in the hollow core 102 via a coherent reflection from the 2-dimensional photonic cladding structure 104, as described in more detail in “Identification of Bloch-modes in hollow-core photonic crystal fibre cladding” by F. Couny, F. Benabid, P. J. Roberts, M. T. Burnett & S. A. Maier, Opt. Express 15 (2007) 325-338 for guidance via photonic bandgap or, in the case of inhibited coupling between cladding modes and core modes, in “Generation and Photonic Guidance of Multi-Octave Optical-Frequency Combs,” by F. Couny, F. Benabid, P. J. Roberts, P. S. Light, and M. G. Raymer, Science 318 (2007), which is incorporated herein by reference.

According to known methods, the core of a HC-PCF can be filled with gas, vapour or liquid in order to implement light guidance in any gas-phase and liquid-phase materials. For example, WO2006/077437 (University of Bath) describes the fibre and structure of highly compact and integrable photonic microcells which consist of a gas-filled HC-PCF hermetically spliced to conventional all-solid optical fibres. These microcells give rise to the potential for developing a new breed of photonic materials, wherein the range of photonic and optoelectronic components is extended to a chosen gas-phase material.

Known microcells as described above are easily integrable into larger optical assemblies, with applications, for example, as gas sensors as well as in stimulated Raman scattering (SRS) and electromagnetically induced transparency (EIT) techniques. However, because these microcells rely on splicing standard optical fibre (solid core based on doped silica) to each end of a section of HC-PCF, light power losses—of the order of 1 dB per splice—are incurred. In their basic form, fibre-integrated microcells therefore reflect only ˜4% of the light at each splice, as a result of which the longitudinal confinement of light in the z direction within the HC-PCF gas cell is minimal.

Recently, conventional Bragg gratings (i.e. gratings in solid standard optical fibres) have been splice-connected to a HC-PCF gas cell to create an optical cavity by strengthening the reflection of light therein. However, due to the inevitable scattering which occurs at each fibre splice, the achievable reflection remains limited in these assemblies and the finesse of the formed cavity remains less than 10. Furthermore, regardless of the formation of Bragg gratings therein, the inclusion of optical fibre sections at either end of a HC-PCF gas cell closes the cavity formed by the core of the HC-PCF. The resulting device is therefore less useful for applications where the introduction and removal of gases or vapours in the microcell without restriction of time is desired (e.g. gas sensor). In addition, for gas-laser interaction enhancement, significant lengths of HC-PCF are required which subsequently necessitate longer time for gas loading.

### STATEMENT OF INVENTION

The invention is set out in the claims. Because a fibre includes an optical propagation core surrounded by cladding, wherein the cladding includes a reflection region of varying refractive index along a longitudinal section of the fibre, full 3-dimensional confinement is achieved within the fibre. There is no need to embed the fibre within portions of standard optical fibre or between any other devices in order to achieve this confinement. Hence a compact optical fibre cavity is provided. The absence of splices and the large reflectivity achievable as a result of the cladding refractive index modulation confers the cavity with large finesse. In particular, by defining the reflection region via formation of a Bragg Grating in the material of the cladding, the fibre can be arranged to act as an air mirror, reflecting the light therein. Air mirrors including Bragg gratings located in the surrounding cladding of the core can have high reflectivity—up to 99.999%—therefore the decay of the light power within the cell is much lower than when the cladded-core fibre is spliced to conventional fibres. The air mirror therefore exhibits high optical finesse and has a relatively large associated quality factor. As a result, the fibre has many applications, including use as an accurate gas sensor, as a gas laser cavity or as a microresonator (the applications related to microresonators will be known to the skilled person). The fibre can furthermore be incorporated into existing devices for implementing SRS, EIT and other techniques, in order to replace the bulky and/or lossy components previously employed in such devices.

Furthermore, because the light can be confined to a very small volume (of the order of micrometers or less) within the core of the fibre and with ultra-low loss, the field intensity of light within the fibre at a given power level is enhanced, thus opening exciting prospect in a number of fields such quantum information, gas and atomic micro-laser and ultra-enhance and rapid gas sensing.

### FIGURES

Embodiments of the figures will now be described with reference to the Figures, of which:

FIG. 1 is a cross sectional view of a known Hollow-Core Photonic Crystal Fibre (HC-PCF);

FIG. 2a shows the period of a Bragg grating according to an embodiment of the present invention;

FIG. 2b shows a HC-PCF including the Bragg grating of FIG. 2a within the fibre, and an incident light mode;

FIG. 2c schematically shows a reflection of the incident light mode of FIG. 2b;

FIG. 2d shows the propagation of the incident and reflected modes of FIGS. 2b & 2c in the Bragg grating

FIG. 2e schematically shows the resultant confinement of the light in all 3 spatial directions.

FIG. 3a shows the relationship between relative reflected power and the detuning parameter Δβ, for various levels of incident mode field overlap with the Bragg grating, at the resonant frequency of the grating, according to an embodiment of the present invention;

FIG. 3b shows a zoomed-in view of FIG. 3a

FIG. 3c shows the relationship between relative reflected power and the grating length, for various levels of mode field overlap with the Bragg grating, according to an embodiment of the present invention;

FIG. 3d shows the relationship between the relative reflected power and the overlap integral coefficient D₁₁, for various grating lengths, according to an embodiment of the present invention;

FIG. 4a shows a scanned electronic micrograph of a fabricated HCPCF according to an embodiment of the present invention;

FIG. 4b shows a computer modelled HCPCF structure extracted from FIG. 4a;

FIG. 4c shows the intensity of a core-guided mode of instant light in the HCPCF of FIG. 4b;

FIG. 4d shows the cladding intensity component of distribution of the incident light at a wavelength away from an anti-crossing event, wherein the entire cladding of the HCPCF of FIG. 4b is doped;

FIG. 4e shows an alternative embodiment wherein only a core ring region of the cladding of the HCPCF of FIG. 4b is doped;

FIG. 4f shows the intensity component distribution within the doped region according to FIG. 4e;

FIG. 4g shows a further alternative embodiment in which only nodes of a core ring of the cladding of the HCPCF of FIG. 4b are doped;

FIG. 4h shows an intensity component distribution of the incident light according to the doping regime of FIG. 4g.

FIG. 5a shows the variation of propagation constant β against wavelengths of light in a hollow core photonic crystal fibre (HCPCF) according to an embodiment of the present invention;

FIG. 5b shows the variation of light transmission with respect to wavelength in the HCPCF of FIG. 5a;

FIG. 6 shows the variation of light transmission loss and overlap of light between the core and the cladding with respect to air filling fraction of a HCPCF according to an embodiment of the present invention;

FIG. 7a shows a HCPCF including multiple Bragg grating regions according to an embodiment of the present invention;

FIG. 7b shows a HCPCF having multiple cladded cores according to an embodiment of the present invention;

FIG. 8a shows a variation of finesse with overlap integral co-efficient for a HCPCF including a Bragg grating of varying length according to embodiments of the present invention;

FIG. 8b shows the variation of finesse with overlap integral co-efficient for a HCPCF including an optical confinement cavity of varying length according to embodiments of the present invention;

FIG. 8c shows the variation of finesse with cavity length in a HCPCF including an optical confinement cavity according to embodiments of the present invention; and

FIG. 8d shows the variation of finesse with cavity length for a HCPCF including an optical confinement cavity, for a variety of overlap integral co-efficient according to embodiments of the present invention

FIG. 9 is a block diagram showing an optical fibre according to an embodiment of the present invention incorporated in a SRS device;

FIG. 10 is a block diagram showing the optical assembly according to an embodiment of the present invention incorporated in a laser frequency locking system;

FIG. 11 is a schematic view of an optical delay circuit according to an embodiment of the present invention;

FIG. 12 is a schematic of an electromagnetically induced transparency (EIT) circuit according to an embodiment of the present invention; and

FIG. 13 is a schematic view of a saturable absorption circuit according to an embodiment of the present invention.

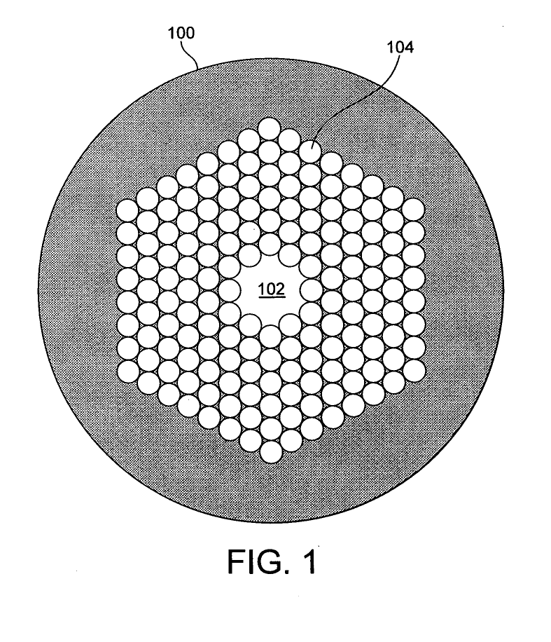

### Overview

In overview the invention relates to optical fibres which can allow the creation of high finesse cavities within gas cells. An optical fibre is provided that comprises a (preferably hollow) core surrounded by cladding, wherein radiation such as light or other optical radiation can propagate through said core. The cladding includes a reflection region of varying refractive index, so that light or other optical propagation is reflected in the core. It will be appreciated that, as a result of this reflection, the core confines light propagation to a limited longitudinal portion (i.e. optical confinement cavity) of the fibre. Because the cladding is arranged to provide light confinement in 2 dimensions, radially outward of the longitudinal direction of the fibre, the fibre exhibits light confinement in 3 dimensions.

The optical fibre is arranged to provide this 3 dimensional confinement in a compact manner, effectively acting as an air mirror, without the need to be embedded within or otherwise operated in conjunction with any additional components. This compactness ensures that light does not have to travel over lengths of solid core fibre in order to be guided into the core of the hollow core fibre or gas cell. Neither does it have to traverse necessarily lossy interfaces between fibre components. Elimination of these aspects serves to reduce light power loss. Furthermore, according to the present invention it is not necessary to use long fibre in order to achieve ultra-enhanced gas-light interaction. This is an important advantage for compactness and for reducing gas loading time in real-time sensing.

Preferably the cavity is defined by the formation of a Bragg grating in the material of the fibre cladding. As a result, an “air minor” is integrated within the fibre, wherein the air mirror is arranged to reflect or “bounce” light within the cavity. This reflection is based on Bragg scattering of the cladding light component of the core mode of incident light that is guided through the hollow core of the fibre, wherein at each interface of the Bragg grating the cladding component of the incident light is both reflected and refracted. This leads to constructive interference, creating a backward-travelling light wave in the cladding. Under “phase-matching” conditions this backward wave is systematically coupled into the core region of the fibre because its propagation constant β matches that of the core-guided incident light mode. And so a reflected, backward-travelling light mode is created in the core.

Efficient reflection is achieved by careful selection of the period Λ_{G} of the Bragg grating, so that the phase matching condition 2β=π/Λ_{G} is met at the central wavelength of operation λ, of the Bragg grating. Here, β is the mode propagation constant, which is a function of the wavelength λ, of the light and is close to the value 2π/λ.

The fibre may have only one grating region and act as a mirror, or may have two grating regions to form a cavity therebetween. The Bragg grating is preferably formed by a periodic variation in the refractive index of the material of the fibre cladding. This variation can be achieved through one or more techniques, including doping, laser lithography or the application of heat or stress to the cladding material. The overlap of the core guided mode of incident light with the grating regions can also be optimized to ensure strong enough reflection without seriously impacting propagation loss within the fibre. This involves the optimisation of the shape of the core and the glass features in the vicinity of the core-cladding interface.

The fibre may include a hollow core filled with gas (here gas can be a molecular gas or atomic vapour) or liquid, or may include a vacuum in its core. Alternatively, the core may be solid. Furthermore, the fibre may enable gas flow throughout its length or may confine gas flow to the length of the optical confinement cavity created by the Bragg grating(s). The fibre may be used in a number of known techniques, including stimulated Raman scattering, laser frequency stabilisation, gas lasers, quantum electrodynamics cavity (CQED), and in electromagnetically induced transparency circuits.

In contrast to known methods wherein either end of a hollow-core gas cell is spliced or embedded to another optical component to achieve 3-dimensional confinement, according to embodiments of the present invention low power loss is incurred at either end of the optical propagation cavity. In conjunction with the particularly low loss for propagation within a hollow core fibre cell, this leads to a high cavity quality factor Q (or finesse) and an associated slow power decay.

### DETAILED DESCRIPTION

Referring to the Figures, the invention can be seen in more detail.

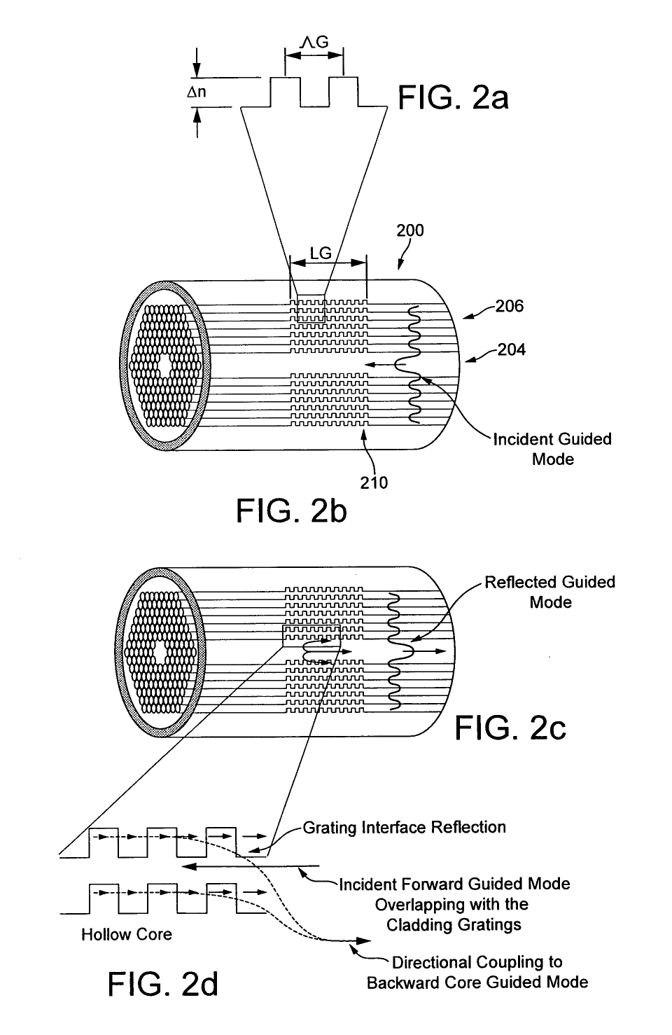

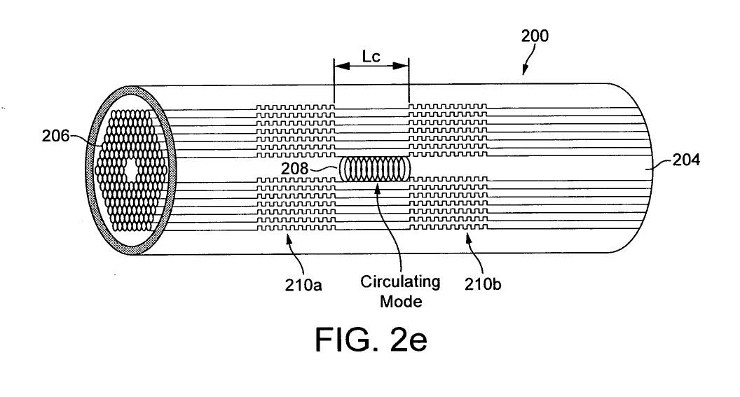

As shown, for example, in FIGS. 2b, 2c and 2e, an optical fibre 200 comprises a Hollow Core Photonic Crystal Fibre (HC-PCF) having a hollow core 204 surrounded by a cladding 206 of silica microcapillaries. A HC-PCF is the preferred waveguide for the optical fibre 200 since it allows unprecedented interaction between light and a gas contained within the core 204 of the fibre. However, it will be appreciated that any appropriate fibre or wave guide may be used. It will further be appreciated that light which is directed along the core 204 of the HC-PCF is confined in two dimensions, radially outward of the longitudinal axis of the core 204, due to the photonic band gap imposed by the holey fibre cross-section of the cladding 206. In the embodiments shown, a portion of the cladding 206 is then arranged to form a longitudinal cavity 208 within the core 204 of the fibre in order to form an “air mirror” and achieve confinement along the 3^{rd} dimension, along the longitudinal axis of the core 204 (0z), so that the HC-PCF exhibits light confinement in all 3 spatial dimensions. As a result, the interaction strength between light and gas in the core of the fibre can be further increased.

### Cavity Formation

The longitudinal optical confinement cavity 208 formed in the HC-PCF is arranged to confine light to a limited volume of the fibre core 204, so that the field intensity at a given power level is much enhanced. Preferably, the cavity 208 is further arranged so that gas, vapour or liquid can either be confined to the cavity 208 or can freely flow through the entire fibre core 204. This makes the optical fibre 200 ideally suited as a compact highly sensitive gas sensor.

According to an embodiment shown in FIG. 2e the cavity 208 is formed by the presence of two longitudinally spaced fibre Bragg gratings (FBG) 210, arranged at either end of the cavity 208, and each extending around the circumference of the core 204. The length (Lc) of the cavity is defined by the longitudinal distance between the two respective grating regions. The skilled person will appreciate that an FBG is achieved by implementing a periodic variation in the refractive index, or “step index modulation”, inside the fibre cladding, as a result of which a wavelength specific dielectric mirror is produced. The refractive index variation can take the form of a square wave, as shown in FIG. 2a, or the wave can be rounded or substantially parabolic in shape. The applications of an FBG include use as an optical filter for blocking particular wavelengths, or as a reflector for particular wavelengths, as described further below.

### Doping

A Bragg grating can be “written” longitudinally into the microstructure of a fibre, for example by using doping techniques, to periodically vary the material of the cladding 206 in a HC-PCF. In order to write an index grating, the material used should be photo-refractive. Moreover, doping may be enhanced with other techniques to achieve improved longitudinal confinement required by the present invention, to ensure that an adequate amount of the guided light field inside a HC-PCF will overlap with the solid material of the cladding 206. It will be appreciated that sufficient overlap of the incident light mode with the fibre cladding is essential to achieve a high proportion of reflected light power in the fibre. The strength of the reflection will further be affected by the refractive index variation Δn within the Bragg grating with which the light overlaps.

A variety of techniques may therefore be employed for strengthening the Bragg grating reflection within a HC-PCF. For example, short sections of the interfaces between the cladding 206 and the core 204 may be made with materials into which high refractive index modulations can be permanently written using an intense interference pattern. Such an index modulation can also be applied, for example, using laser lithography. Within the cladding, the refractive index (n) along a particular radius may be constant, or may taper off towards the outer circumference of the fibre.

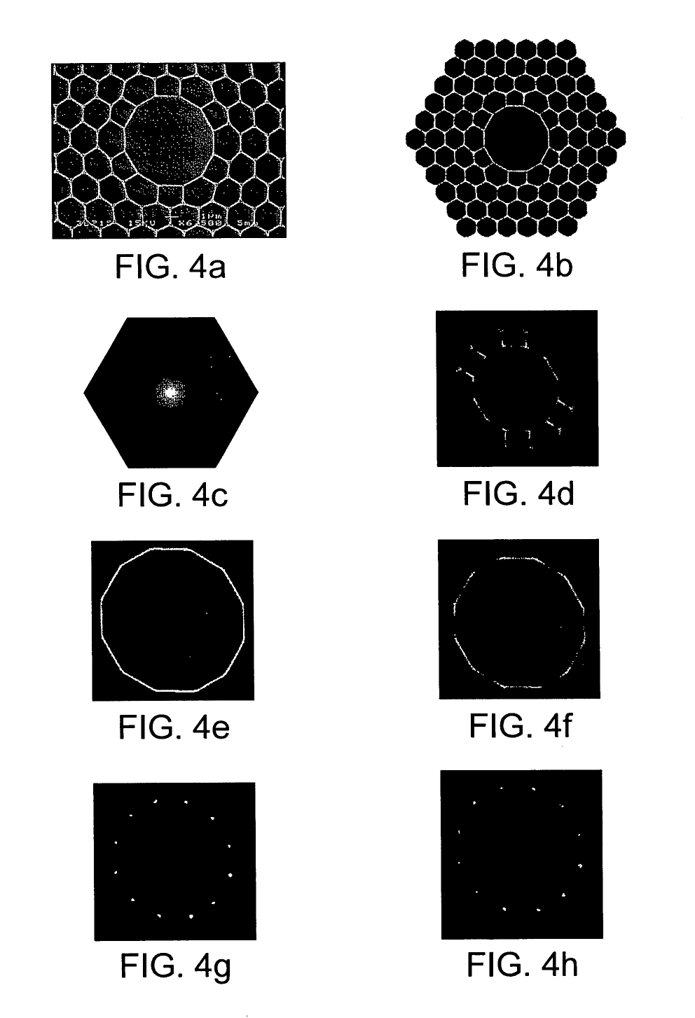

The Bragg grating should preferably be implemented in a complete ring around the longitudinal section of the core within which reflection of the incident mode of guided light is to occur. The refractive index variation necessary to create the Bragg grating can be implemented throughout the radial extent of the cladding along its longitudinal section in question, as is the case in FIG. 4d. Alternatively, a Bragg grating may be implemented in a single ring at a fixed radius within the cladding. For example, FIG. 4e shows an embodiment wherein doping to create a Bragg grating is implemented only in the core ring, i.e. the first radial layer of microcapiliaries within the cladding that surrounds the core of the fibre. A single ring of Bragg grating could be created at any radial distance from the core within the cladding. Furthermore, it is not necessary to implemented the Bragg grating in a continuous ring. Instead, the refractive index variation could be implemented in an arc or a segment of the cladding. Alternatively, as depicted in FIG. 4g, only the interstitial features, i.e. the apexes of the hexagonal capillary holes within the cladding, may be doped. In FIG. 4g only the interstitial features of the core ring are doped.

### Other Cavity Properties

Additionally or alternatively, in order to improve the Bragg grating reflection within a HC-PCF the cross sectional shape of the core 204 can be designed so to ensure sufficiently low-loss guidance of light within the fibre whilst providing a stronger power overlap of the light field with the cladding 206. Possible embodiments include substantially circular or triangular cores so to increase the electromagnetic field overlap between the core and the cladding regions. This will enhance the overlap integral D_{1,1}, and consequently improve reflection of light in the fibre.

Further additionally or alternatively, when forming a Bragg grating in a Hollow-Core Photonic Crystal Fibre according to the present invention, the operational wavelengths of the fibre may be optimised with respect to mode anti-crossing events which occur in HC-PCF. This is so because at a wavelength corresponding to an anti-crossing event, there a huge enhancement of the overlap between the light field incident inside the core of the fibre and the grating, whilst also maintaining adequate overlap of the light with any gas, vapour or liquid inside the core 204. One possible technique for achieving this optimisation is to adjust the thickness of the doped region within the cladding, to determine the frequencies at which “surface modes” occur, as described further below.

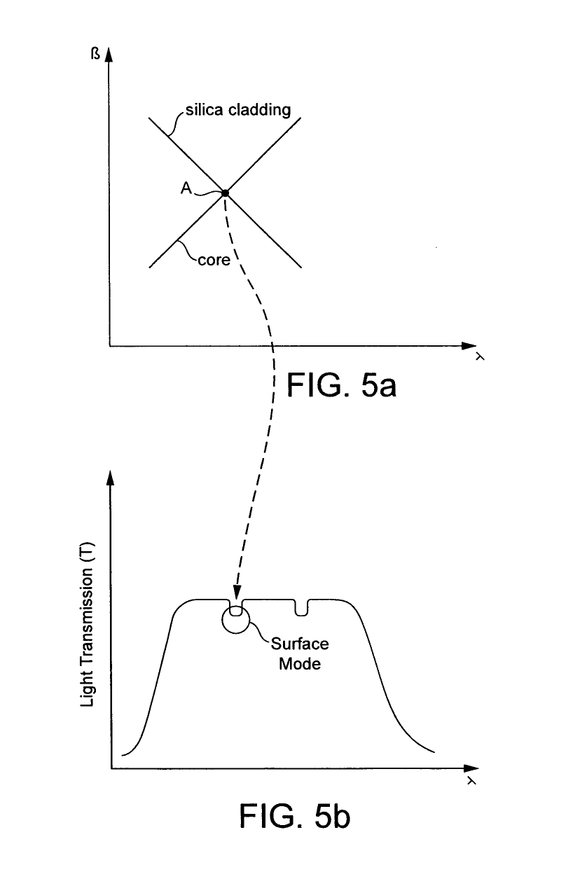

FIG. 5a shows the variation of propagation constant β against wavelength of light for both the hollow core and the silica microcapiliaries of the cladding of a typical Hollow Core Photonic Crystal Fibre (HCPCF). At point A on FIG. 5a, the traces for the core and cladding intersect one another. This is known as an anti-crossing event. As shown in FIG. 5b, the wavelength at which such an anti-crossing event occurs corresponds to a “surface mode” in the transmission of the fibre, at which point the x-y spatial confinement achieved by the photonic band gap of the cladding structure is temporarily reduced. Therefore, more light is lost from the fibre at this wavelength but, due to propagation constant matching, the light power overlap between the core and the cladding is greatly enhanced. Therefore a large overlap integral (D₁₁) and consequently a strong reflected signal is created.

By an interplay of: the refractive index modulation depth Δₙ in the cladding (i.e. the effective contrast between the low index and the high index), which is determined by the choice of the doped material and the index modulation technique; the field overlap, which is determined by fibre structure (core-shape, cladding and anti-crossings); and the length of the grating section, it is possible to achieve reflection of >95%. In practical applications, it is preferable to have higher index modulation and stronger field overlap so as to achieve such high reflection with short grating lengths.

### Air Filling Fraction

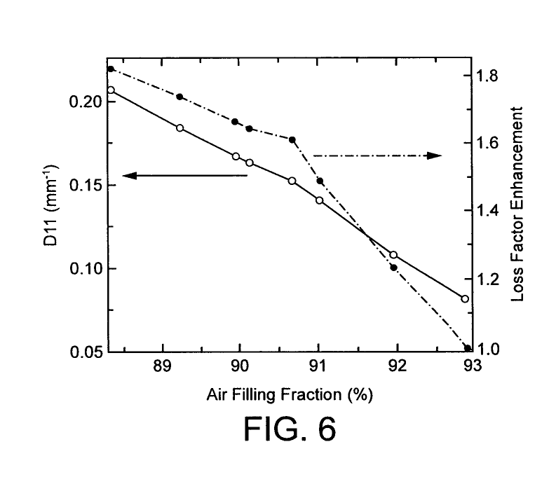

A further property that affects the cavity formation in a fibre, in particular the extent of the overlap between the incident guided light mode and the cladding material, is the “air filling fraction”, i.e. the percentage air filling of the microcapiliaries of the cladding of the fibre. FIG. 6 shows the dependence of the transmission loss (loss factor enhancement) and the overlap integral (D1,1) on the air filling fraction of a hollow core photonic crystal fibre for a low loss spectral region. As shown therein, a lower air filling fraction leads to a higher loss factor enhancement and thus reduces confinement of light in the xy direction of the fibre. Conversely, a lower air filling fraction leads to a higher overlap integral and thus improves reflectivity in the z direction within the fibre core. Hence in practice a balance should be struck between overlap integral and loss factor enhancement when considering air filling fraction of the fibre cladding.

### Self-Directional Reflection

As discussed above, the optical fibre of FIGS. 2b and 2c operates as a grating-assisted self directional reflector, or so-called “hollow mirror”. The grating-assisted reflection relied on by the mirror is illustrated schematically in FIGS. 2a through to 2d. Preferably, the cladding 206 includes silica (SiO₂) microcapillaries doped by, for example, Germanium (Ge). As discussed above, the doping extends along longitudinal sections of the fibre cladding, so that a periodic refractive index contrast is created within it, for example by the application of an intense longitudinal laser interference pattern. FIG. 2a shows the period Λ_{G} of the grating that is formed in the optical fibre 200 of FIGS. 2b and 2c.

As shown in FIG. 2b, when incident light is guided along the core 204 of the HC-PCF the incident guided mode of the light field extends into the cladding 206 and overlaps with its constituent microcapillaries. Implementing a longitudinal refractive index change in these constituents, for example by doping or any other suitable technique as described above, creates a Bragg grating that in turn leads to the creation of a reflected component of the incident light field, which couples into the core and propagates inside the HC-PCF as a back-reflected wave. The optical fibre of FIG. 2e operates in an identical manner, with grating-assisted reflection occurring at either end of the optical confinement cavity 208 due to the presence of the first 210a and second 210b Bragg gratings. Hence, light “bounces” back and forth within the cavity 208.

By virtue of ensuring that the phase-matching condition between corresponding forward and backward going core modes, when mediated by the grating spatial frequency 2π/Λ_{G}, is substantially satisfied, the back-reflected wave generated in the HC-PCF is a core guided-mode which largely corresponds to a simple Bragg reflection. However, because the reflection is due to the small overlap of the guided mode with the material within the cladding 206, rather than the field component in the core 204 itself, we refer to this type of reflection effect as “self-directional reflection”.

The self-directional reflection effect observed according to the invention arises as a result of mode matching between the backward optical field in the cladding 206 and that of the core 204. The principles of mode matching are well known and used, for example, in directional couplers (e.g. wavelength division multiplexing WDM). In particular when an electromagnetic radiation propagates in a first medium, its field will nonetheless extend beyond the medium. If the field overlaps into another medium then in certain conditions of mode match, the radiation could be strongly coupled to the further medium. For example in WDM light propagating in a first fibre can “jump” or “cross over” into a mode matched proximal fibre.

In the case of HCPCF, it will be appreciated that although the light is guided in the core the field overlaps into the cladding. Consequently, when a Bragg grating is implemented in a section of the cladding, the field propagating in the cladding is reflected by the Bragg grating. By virtue of the mode matching between the cladding and the core, the reflected field systematically propagates in the core-mode such that the light propagating in the core is also reversed, creating the “air mirror” effect. The effect is analogous to the WDM example given above; the field propagating in the cladding is reversed and “crosses over” to the core such that the entire field propagates in the opposite direction.

It will be noted that the region of varying refractive index (providing confinement in the z direction) need not coincide fully with the region of periodicity providing the photonic band gap and confinement in the x-y plane, as long as there is sufficient field overlap in the varying refractive index region. Indeed the air mirror effect can be attained in any hollow core fibre or other radiation guide having a Bragg grating or other suitable region of varying refractive index into which the field penetrates.

### Designing a Self-Directional Reflector

In order to achieve self-directional reflection, the fibre cladding 206 should be designed so that the propagation constant “β” of the incident guided mode and the grating period Λ_{G} are related by the relationship: (2π/Λ_{G})=2β. This ensures that the grating is concurrently phase-matched with codirectional and contradirectional waves. Consequently, light travelling in the core 204 at frequencies matching the resonance conditions of the cavity 208 will experience a reflection, as a result of which a strong and resonant back-reflected wave is generated, having the same propagation constant as that of the incident guided mode. As illustrated in FIG. 2d, the strength of the reflection is determined by the strength of the power overlap of the incident guided mode with the grating, the longitudinal length L_{G} of the grating, and the height Λₙ of the step index modulation in the grating 210.

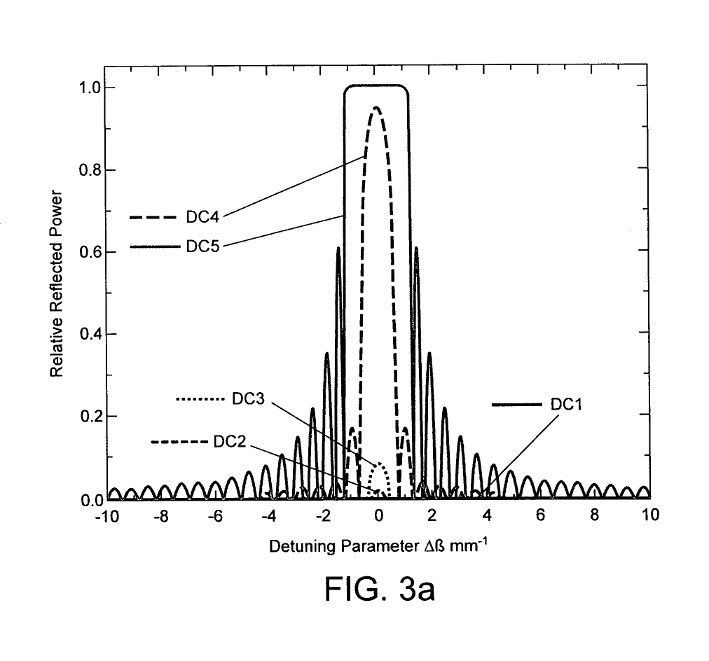

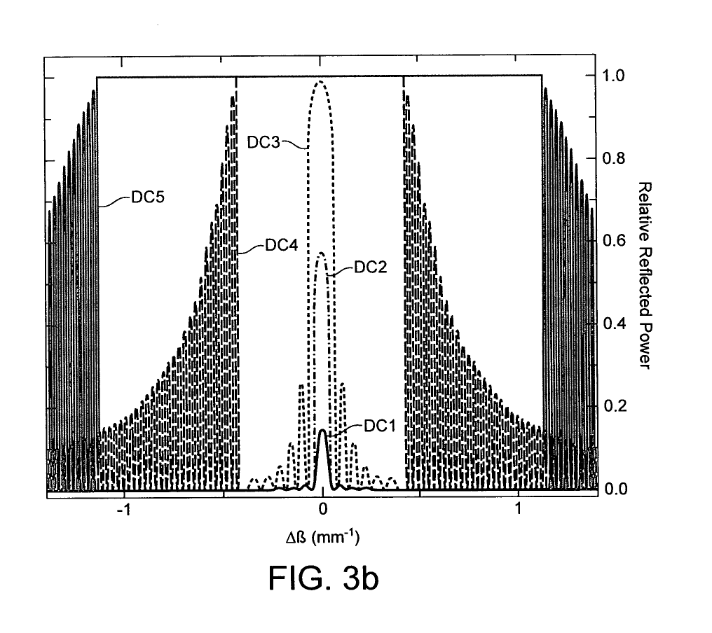

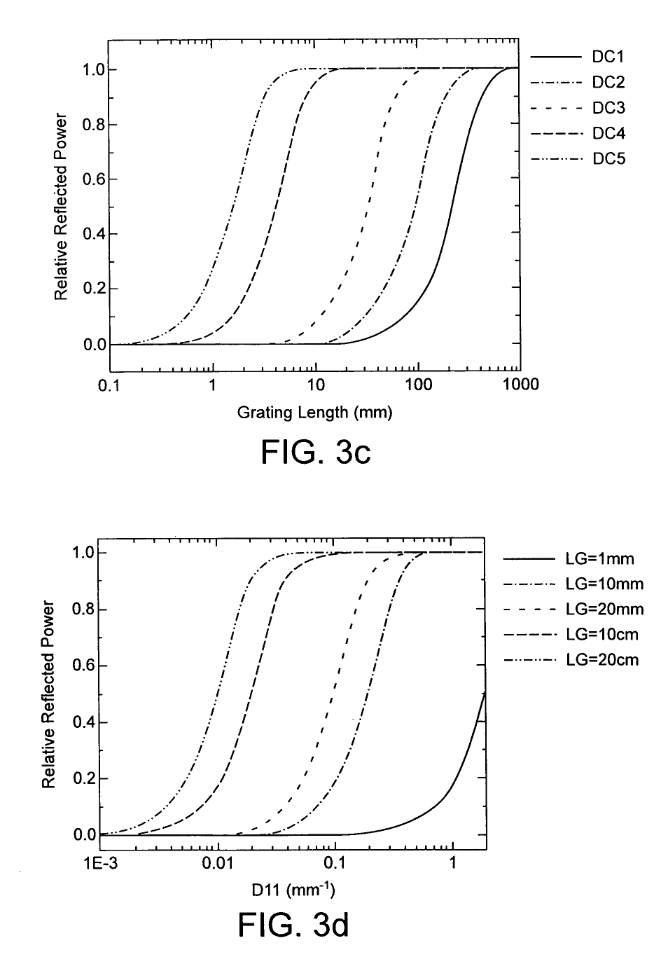

FIG. 3d shows the relationship between relative reflected power and the overlap integral coefficient D₁₁ for a Bragg grating of index modulation 0.1% for 5 possible lengths of cavity, wherein:

### L_{G1}=1 mm

### L_{G2}=10 mm

### L_{G3}=20 mm

### L_{G4}=10 cm

### L_{G5}=20 cm

It will be appreciated from FIG. 3d that a Bragg grating of length L_{G}=20 cm can achieve 20% relative reflected power with a relatively low overlap. Conversely, a relatively small grating of length L_{g}=1 mm requires a much larger overlap integral coefficient in order to achieve good relative reflected power. In practical applications such as QED it is preferable to reduce the length of the Bragg grating. In arrangements having two grating regions defining a cavity or gas cell therebetween, the photons of light in the cavity will bounce back and forth along the cavity such as that they “see” a long effective length within the cavity, whereas the gas molecules only see a short length of L_{G}. It is thus desirable to reduce the size of L_{G} for practical applications.

### Air Mirror

Because self-directional reflection in HC-PCF and other fibres results in the formation of a reflected core mode which is identical to the incident guided core mode of light inside the fibre, but travelling in the opposite direction, a self-directional reflector can be regarded as being an “air mirror”. Air mirrors are extremely useful in practical applications since they can operate with very high power but yet require no material for their formation, other than the cladding surrounding the core of the fibre in which the light or other electromagnetic radiation is reflected. Applying a vectorial form of the coupled-wave theory approach the reflectivity (r) and the transmitivity (t) of such an air mirror are given by:

$$\begin{matrix}{r}_{- 1 , 1} = - \frac{η Sinh ( S {θ}_{L} )}{S Cosh ( S {θ}_{L} ) + ( i σ / 2 ) Sinh ( S {θ}_{L} )} , \\ and & ( 1 ) \\ {t}_{1 , 1} = \frac{exp ( iσ {θ}_{L} / 2 ) S}{S Cosh ( S {θ}_{L} ) + ( i σ / 2 ) Sinh ( S {θ}_{L} )} & ( 2 )\end{matrix}$$

Wherein: θ_{L} is a measure of the resonance of the Bragg grating in operation, and is given by:

$${θ}_{L} = \frac{{\overline{D}}_{1 , 1}}{2} {L}_{G} \qquad ( a )$$

D̅_{1,1} and D̅_{-1,} are the overlap integral coefficients: D̅_{1,1} is a measure of the overlap between the incident guided core mode field intensity and the grating, whereas D̅_{-1,1} is a measure of the overlap between the forward and backward going guided core mode fields and the grating. These quantities are defined more precisely below.

Ω is the pitch or frequency of the Bragg grating, and is defined by

Ω=2π/Λ_{G} (b)

Δβ is the detuning parameter between the grating and the forward and backward going core modes, and is defined by:

Δβ=Ω−β₁ (c)

wherein: β₁=β₋=β=the propagation constant of light travelling in the core

Detuning can be further represented by σ wherein;

$$σ = \frac{2 Δ β}{{\overline{D}}_{1 , 1}} \qquad ( d )$$

The asymmetry between the overlap of the backward and forward travelling modes is represented by η, wherein:

η= D̅_{-1,1}/ D̅_{1,1} (e)

And a normalisation constant, S, can be calculated wherein:

S=\sqrt{η²−(Δβ/ D̅_{1,1})²} (f)

As the skilled person will appreciate, a “+1” label indicates the incident wave travelling in the positive direction and a “−1” label indicates the reflected wave travelling in the negative direction. Represented mathematically:

j,l∈[1,−1] (g)

By applying the theory of coupled-waves between two waveguides to the equations above, the refractive index (n) variation required within the fibre in order to provide a Bragg grating that gives rise to the required reflection and consequently confinement effects can be obtained. If the index variation is described by

n(r,z)= n̅(r)+Δn(r)sin(Ωz) (3)

where the amplitude of the index variation Δn(r) is assumed small, the coupling coefficients are determined by:

$$\begin{matrix}{D}_{jl} ( z ) = \frac{k}{4} {( \frac{{ɛ}_{0}}{{μ}_{0}} )}^{1 / 2} {\int }_{{A}_{∞}} {d}^{2} r ( {n}^{2} - {\overline{n}}^{2} ) \{ {\hat{e}}_{t , j}^{*} \cdot {\hat{e}}_{t , l} + \frac{{\overline{n}}^{2}}{{n}^{2}} {\hat{e}}_{z , j}^{*} {\hat{e}}_{z , l} \} ≅ {\overline{D}}_{jl} sin ( Ω z ) \\ where & ( 4 ) \\ {\overline{D}}_{jl} = \frac{2}{Λ} {\int }_{0}^{Λ} d z {D}_{j , l} ( z ) sin ( Ω z ) ≅ \frac{k}{2} {( \frac{{ɛ}_{0}}{{μ}_{0}} )}^{1 / 2} {\int }_{A ∞} {d}^{2} r n ( r ) Δ n ( r ) {\hat{e}}_{j}^{*} \cdot {\hat{e}}_{l} & ( 5 )\end{matrix}$$

### Wherein:

∈₀ is the permittivity of free space,
μ₀ is the permeability of free space,
k is the wave number of the light k=2π/λ, with λ the wavelength,
êⱼ=ê_{t,j}+ê_{z,j}\hat{z} is the electric field distribution of the guided mode, normalized according to Allan W. Snyder and John D. Love, “Optical waveguide theory”, Chapman and Hall (New York, 1983)
A_{∞} denotes that the entire cross section of the fibre is integrated over

### Practical Considerations

In order to realize meaningful air mirrors, as formed from micro-cavities as depicted in FIGS. 2a to 2e and as described above, the extent of overlap between the light inside a HC-PCF and the cladding 206 should be precisely determined, in order to assess the Bragg grating. When designing a suitable HC-PCF or other fibre to achieve Bragg reflection, and hence 3-dimensional confinement of light therein, it is important to ascertain the required length of grating and the grating parameter tolerances. The length and tolerances are driven by the index modulation of the grating, which will be assumed to vary sinusoidally along the fibre's longitudinal axis direction 0_{z}, and the modal overlap with the grating region. It will be appreciated that a range of different doping topology distributions within the cladding 206 can be used in order to achieve this variation.

FIG. 3a shows the relationship between detuning parameter Δβ and relative reflected power for a Bragg grating that is 1 cm long (L_{G}=1 cm). As the skilled person will appreciate, Δβ represents the bandwidth of the grating for each particular doping configuration. The amplitude of the index modulation within the grating region as a function of the radius of the grating, and compared to the refractive index of glass (ngl) is given by Δn(r)|_{within grating}/n_{gl}=2%. This amplitude is within the typical range of what is achievable with presently existing techniques.

The possible doping configurations (DC) depicted in FIG. 3a include

DC1=Low loss whole clad—wherein the whole cladding is doped
DC2=Low loss core guided mode—wherein just the glass ring that surrounds the core is doped
DC3=Core surround mode—wherein all solid cladding components within a predetermined cross-section are doped and inscribed with a grating
DC4=Anti-crossing (AC)—wherein doping is arranged so that reflection in the grating occurs at an anti-crossing as described above.
DC5=Interstitials—wherein only the apexes of the hexagonal holes of the cladding are doped

FIG. 3b shows the relationship between the detuning parameter Δβ and relative reflected power a Bragg grating of length 1 [cm]| for the same five doping configurations, zoomed in to show more clearly DC1, DC2 and DC

FIG. 3c shows the relationship between grating length L_{G} and relative reflected power for a Bragging for the same five doping configurations. Again it can be seen that a longer grating length encourages higher relative reflective power and that the interstitials doping regime enables 100% relative reflective power with a Bragg grating a length of less than 10 mm. However each of the other four doping configurations can also lead to 100% relative reflective power, but would require a longer grating length in order to do so.

### Real World Example

The table below shows the reflection parameters of an air mirror formed from a low loss HCPCF with an air filling fraction of 93% for a number of different doping configurations. In the fifth column the doped region extends to the whole cladding of the fibre but the guided mode of incident light is localised at the core ring rather than being a hollow core guided mode (i.e. it is a silica guided mode). The fibre core has a size corresponding to 7 unit cells. The dimensions of the fibre are can be tailored to suit the operating wavelengths. Typically the core size is between 5 μm to 20 μm.

| | Doping Configuration | | | | |
|---|---|---|---|---|---|
| | | | | | Whole cladding |
| | | | | | (excitation |
| | Whole | Inter- | Core- | Anti- | of the core- |
| | cladding | stitials | ring | crossing | surround mode |
| Index | 0.1% | 0.1% | 0.1% | 0.1% | 0.1% |
| modulation | | | | | |
| Δn | | | | | |
| Power | 0.47% | 0.24% | 0.16% | 3.4% | 10.1% |
| fraction in | | | | | |
| doped silica | | | | | |
| consituent | | | | | |
| D₁₁ (mm⁻¹) | 1.4 | 0.68 | 0.46 | 10.7 | 27 |
| η | 0.8 | 0.92 | 0.86 | 0.8 | 0.84 |

It can be seen again that an anti-crossing doping configuration gives a relatively high percentage of light power in the cladding of the fibre and therefore enables a relatively high overlap integral co-efficient, which will lead to a relatively high reflective power in the backward travelling wave within the air minor.

### Multiple Cavities

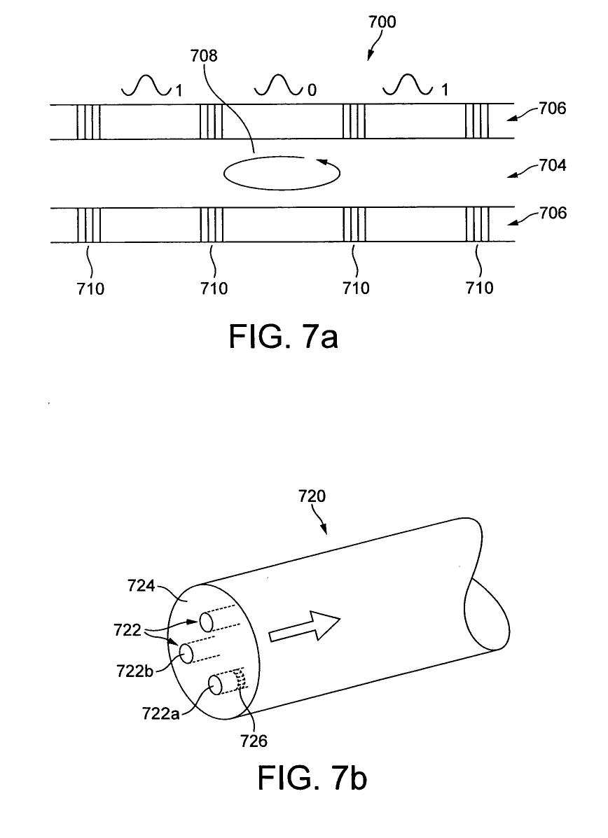

It is possible to use a plurality of grating regions along the longitudinal extent of a HCPCF or other fibre. For example, as shown in FIG. 7a, multiple optical confinement cavities 708, defined by Bragg gratings 710 having different respective resonant frequencies, can be formed in the cladding 706 surrounding the core 704 along the length of a fibre 700. Dependent on its resonant frequency, each grating 710 will affect a different wavelength of incident light. A plurality of gratings 710 can be implemented symmetrically about a longitudinal point in the fibre 700, which can be employed for example to create cascading laser amplification of light in the gas filled core of HCPCF.

In addition, it is possible to implement the self-directional coupling effects described above using two or more closely spaced or overlapping conventional optical waveguide fibres. One or more Bragg gratings is formed in the first fibre and incident light is directed into the second fibre and will, as a result of the self directional reflection coupling described above, “jump” into the first fibre and travel backwards therein as a reflected wave. Furthermore, according to an embodiment of present invention as shown in FIG. 7b a fibre 720 is provided having multiple longitudinally extending cores 722 therein, surrounded by cladding 724, wherein a Bragg grating 726 is formed in the cladding surrounding a first core 722a and light is incident into a second core 722b such that self-directional reflection will cause the light incident into said second core 722b to “jump” into the first core 722a in order to travel backwards as a reflected wave. In each of these embodiments, a grating is provided in or for a fibre or core that incident light is not guided into, yet light will be reflected backwards along that core or fibre.

According to a preferred embodiment of the arrangement of FIG. 7b, the second core 722b is filled with a gas which will interact with a forwards or backwards reflected wave from the first core 722a. This embodiment has application in analysing the gas within the second core 722b. This embodiment further has the advantage of quick and continuous analysis of the gas, and can contribute to ease of filing of the gas in the second core 722b. Preferably the first 722a and second 722b cores are pumped or filled with different gases that lased or resonate at different wavelengths. A gas is emitted or lased at a given wavelength in the first core 722a and, by an appropriate arrangement of Bragg grating in the cladding surrounding all or a section of the first core 722a, the emitted wavelength is then guided backward or forward in the second core 722b in which it will interact with the second gas.

### Finesse

As discussed above, the fibre shown in FIG. 2e includes first 210a and second 210b Bragg gratings in the material of the fibre cladding 206 that define an optical confinement cavity 208 of length L_{cav} therebetween. Both Bragg gratings 210a, 210b exhibit substantially sinusoidal variation in refractive index and therefore induce self-directional coupling of light within the fibre as discussed above. It follows that, because the self-directional reflection described above results in the formation of a reflected core mode which is identical to the incident guided core mode of light inside the HC-PCF, when a negatively-travelling reflected core mode reaches the incident end of the cavity 208 in FIG. 2e it will be reflected again in a similar manner, and thus will propagate in the positive direction along the core 204 of the fibre. Therefore the cavity 208 created inside the HC-PCF causes light to “bounce” back & forth along its length L_{cav}.

The measurement of the number of “bounces” achieved by a cavity is known as the “Finesse” (F) of the cavity. As will be appreciated by the skilled person, Finesse is a figure of merit which determines how well light is confined in the cavity. For example a Finesse of 10⁵ corresponds to an effective length of 10⁵×Lcay. In other words, if for a particular application one would previously have needed 100 m of low-loss fibre, according to the present invention we can use a 1 mm long cavity to do exactly the same job. Furthermore the higher the Finesse, the more efficient/compact the resulting products e.g. lasers or CQED are.

The finesse is given by:

$$F = \frac{π \sqrt{\vert r \vert {e}^{- α ( {L}_{cav} + 2 {L}_{eff} )}}}{1 - \vert r \vert {e}^{- α ( {L}_{cav} + 2 {L}_{eff} )}} \qquad ( 6 )$$

### Wherein

α is the intrinsic loss per unit propagation length, due to, for example, random inhomogeneity or interface roughness scattering. This is assumed the same within fibre sections in which a grating has been written as within the un-doped HC-PCF section.
L_{cav} is the actual physical length of the cavity and
L_{eff} is the effective length of each of the Bragg mirrors, which is given by

$${L}_{eff} ≡ \frac{{\int }_{0}^{LG} \vec{E} \vec{D} d z}{{( \vec{E} \vec{D} )}_{max}} \approx \frac{1}{{\vert E \vert}_{max}^{2}} {\int }_{0}^{LG} {\vert E ( z ) \vert}^{2} d z \qquad ( 7 )$$

E: electric field
D: displacement field
L_{G}=length of the grating region

Expressed another way:

$${L}_{eff} = \frac{1}{Cosh ( η {D}_{11} {L}_{G} / 2 )} ( ( {L}_{G} / 2 ) + ( 1 / 2 η {D}_{11} ) Sinh ( η {D}_{11} {L}_{G} ) ) \qquad ( 8 )$$

In real terms, the effective length is the length of the light field in the air minor that the cavity 208 creates, taking into account the number of bounces and hence the distance traveled by the light before decay. That is, it is the length that a light photon “sees” in the cavity. It will be appreciated that it is desirable for practical applications that the cavity 208 enables light to bounce back & forth a number of times before its power decays to negligible levels. According to the present invention, the decay of the light field in the air minor can take place over a large length because of the small modulation and the large length as compared to multistack mirrors. As a result of this, the finesse for the cavity 208 is high in comparison to known microcells.

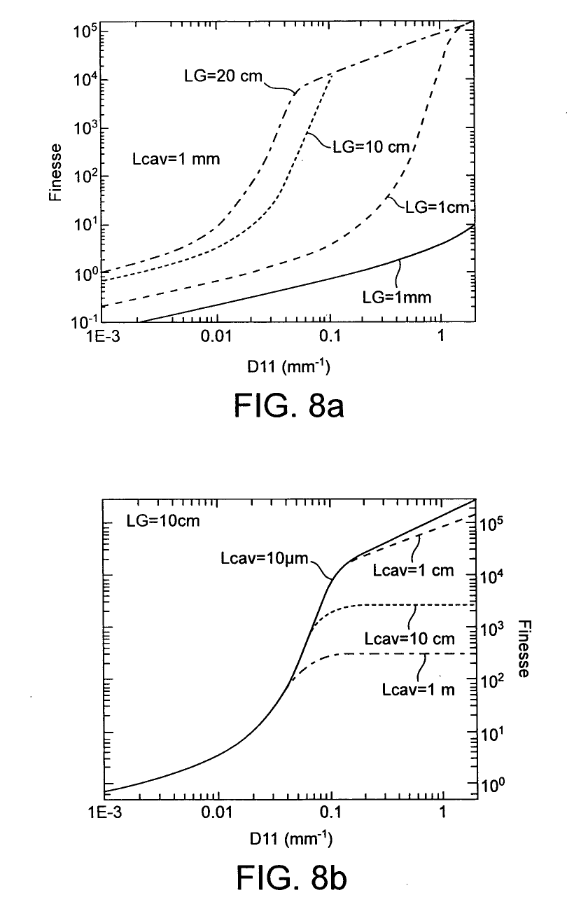

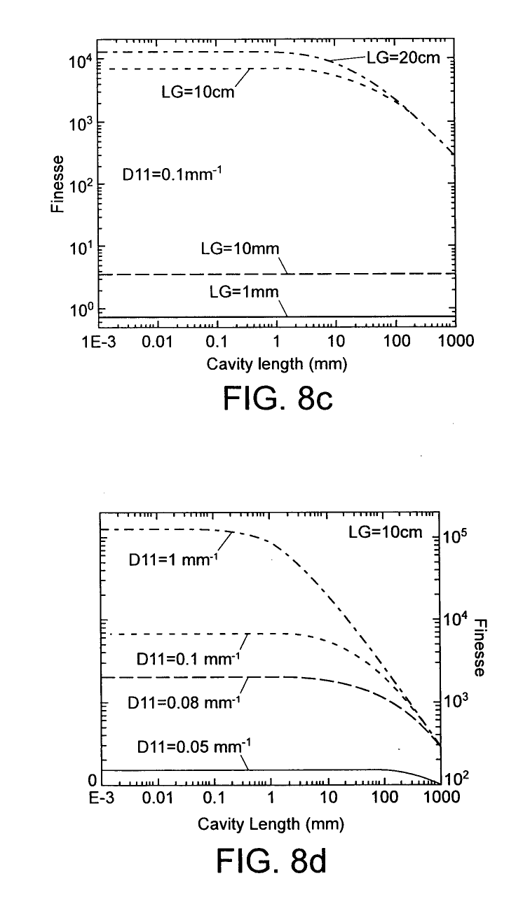

FIG. 8a shows the relationship between finesse and overlap integral coefficient for an optical confinement cavity of length 1 mm, wherein that cavity is formed by at least one longitudinally spaced Bragg grating, for a number of different lengths (L_{g}) of the grating. It can be seen here that a long grating can achieve relatively high Finesse with a relatively small overlap integral co-efficient as compared to the Finesse achievable from a much smaller grating for the same overlap.

FIG. 8b shows the relationship between Finesse and overlap integral coefficient for a number of cavity lengths wherein those cavities are formed by at least one Bragg grating of length L_{g}=10 cm. FIGS. 8c and 8d show the relationship between finesse and cavity lengths when the Bragg grating length and the overlap integral coefficient respectively are varied.

It will be appreciated that in order to achieve high Finesse in practical applications it is necessary to balance the sometimes conflicting requirements of overlap grating length and cavity length to achieve as many light bounces as possible in a cavity. Ideally, for QED applications a Finesse of 10⁵ is desirable. However, lower Finesse still produces good results for laser applications.

### Quality Factor Q

A property of the cavity 208 that is related to its finesse (F), and hence is increased according to embodiments of the present invention, is the quality factor (Q). As is known to the skilled person, Q is a measure of the resonant frequency of a cavity as compared to the bandwidth of its resonance. Furthermore, the average lifetime of a resonant (i.e. bouncing) photon in the cavity is proportional to the cavity's Q. For the present invention, Q is given by:

$$Q = \frac{{v}_{0}}{F S R} F \qquad ( 9 )$$

### Wherein

F is the finesse of the cavity and FSR is a frequency determined by L_{cav}

### Modal Volume

According to the present invention, the modal volume of the cavity can be expressed by:

V=A_{eff}×(L_{cav}+2L_{eff}) (10)

Where A_{eff} is the effective area of the mode light, which can be approximated as

A_{eff}=(9/4)πr_{hc}²

Wherein r_{hc} is the radius of the core of the Hollow-Core Photonic Crystal Fibre For non-linear interactions it is desirable to have a low modal volume. This is particularly important for highly coupled regimes such as QED.

### Alternatives

It will be appreciated that the present invention does not only apply to HC-PCF when filled with gas, liquid or vapour. As an alternative to applications as described above involving light/gas interactions, the cavity formed in a HC-PCF can be arranged to act as a laser medium. In order to achieve this, the material forming the HC-PCF cladding in the vicinity of the core can be, for example, glass doped with active species such as Yb³⁺ or Er³⁺. These ions are optically pumped so that the cavity can act as a laser medium. To achieve both sufficient gain and reflection in the cavity, the laser output wavelength can be chosen to be close to an anti-crossing event. The gas used can be an excimer such as carbon dioxide. Alternatively, Xenon may be used

A long-period grating could be envisaged within a cavity formed by first and second Bragg gratings, as shown in FIG. 2e. This could be used to convert light amplified within a mode concentrated in the doped glass material (and hence subject to high gain) into the low loss and low nonlinearity HE₁₁-like mode of the hollow core. This would enable a compact all-fibre laser device with a relatively low NA output (so well collimated) which is free from fibre splices and awkward free-space optics.

### Applications

Embodiments of the present invention have a wide range of practical applications for example in reflectors and gas circulators and in a variety of aspects of telecommunications. They can further be implemented in apparatus for efficient laser frequency conversion using gas phase Raman line generation and can be integrated into a laser related device such as a stimulated Raman scattering (SRS) device as described further below. Because the fibre according to the present embodiments does not use splices or additional physical components at either end of a gas cell but instead employs Bragg gratings to create an optical confinement cavity within an optical waveguide, power loss at either end of the cavity is significantly reduced. Furthermore, gas can be introduced into or removed from the optical confinement cavity in situ within a device because either end of the optical propagation cavity is not physically blocked off.

The fibres according to embodiments of the present invention can be employed for frequency standardisation using gas or vapours such as rubidium, caesium, hydrogen or acetylene. Frequency standardisation can be achieved with the fibres using electromagnetically induced transparency (EIT) or saturable absorption (SA) effects, both of which are manifestations of light gas interaction that are not subject to Doppler broadening. These effects are discussed in more detail below.

An optical fibre according to embodiments of the present invention may further be utilised as a light buffer and in slow light techniques

According to the present invention, an optical fibre including a HC-PCF having a cavity formed therein can be filled with gas according to any appropriate technique to form a gas cell, for example as described in WO2006/077347 (University of Bath) and used as an accurate gas sensor. Because the HC-PCF does not have to be spliced to lengths of standard optical fibre in order to achieve 3 dimensional confinement, the resultant fibre is highly compact as compared to known gas cells. In addition, light power losses at either end of the cell are significantly reduced. Furthermore, gas-loading time for the fibre is significantly reduced.

As indicated above, the optical fibre according to the present invention is capable of being integrated into several laser-related devices. For example, it may be used in a Stimulated Raman Scattering (SRS) device. SRS is described in this context in Benabid et al which is incorporated herein by reference. SRS is a two-photon inelastic light scattering process, whereby an incoming photon (pump) interacts with a coherently excited state of the Raman medium, and as a result, either a frequency downconverted (Stokes) or upconverted (anti-Stokes) photon is emitted. SRS is an ideal method for providing efficient laser frequency conversion and high-resolution spectroscopy. Up until recently, however, to achieve reasonable frequency conversion efficiency, high power lasers (≧MW) were required, severely limiting the potential applications of SRS in nonlinear optics and technology. Conventionally, the threshold power for gas-SRS (the pump power required to achieve ˜1-2% conversion to the Stokes) has been reduced by using multi-pass cells or resonant high finesse Fabry-Pérot cavities. Limitations of these approaches include that the reduction of the threshold is limited, the apparatus is voluminous and the conversion to the Stokes remain poor.

As a potential solution to these problems, “Stimulated Raman Scattering in Hydrogen-Filled Hollow-Core Photonic Crystal Fibre, “Benabid et al proposes a different approach to generating SRS, using hollow-core photonic crystal fibre filled with Raman active gas. This has lifted the longstanding reliance of SRS on powerful lasers, thus making the approach an ideal way for efficient SRS generation. In “Ultra-high efficiency laser wavelength conversion in gas-filled hollow core photonic crystal fibre by pure stimulated rotational Raman scattering in molecular hydrogen”, PRL, volume 93, issue 12, page 123903, the same authors also demonstrated that using a 35 m long fibre with inner diameter of ˜7 μm could reduce the power required for Stimulated Raman Scattering (SRS) generation by a factor of 1 million. In both these cases, however, it was necessary to use cumbersome gas delivery chambers at the end of the fibre.

A further potential solution to these problems is described in WO2006/077437 (University of Bath), wherein a HC-PCF hydrogen gas cell is confined along its longitudinal axis by optical fibres spliced at either end of the gas cell, and incorporated into an SRS device. However, as will be appreciated from the description above, the presence of the splices at either end of the gas cell leads to significant power loss in the cell.

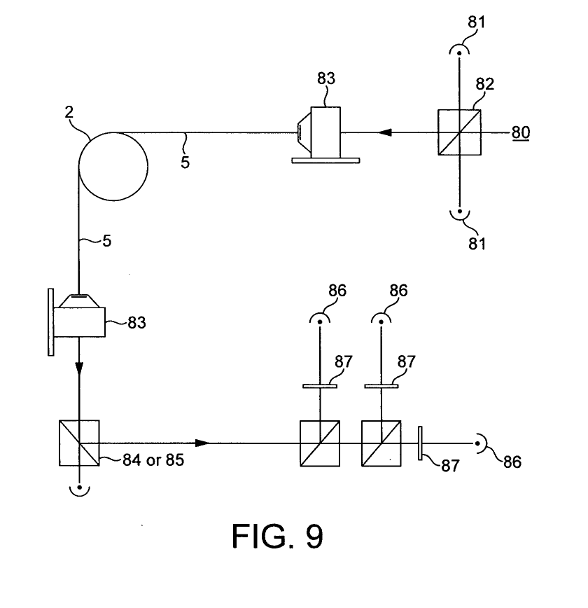

As an improvement over the teachings of WO2006/077437, the gas cell according to the present invention is filled with hydrogen gas and incorporated into an SRS device as shown in FIG. 9. The gas cell is pumped with a Q-switched single-mode frequency-doubled Nd:YVO₄ laser (not shown) operating at a wavelength of 1047 nm, with a pulse-width tunable in the range 6 ns to 50 ns and generating a beam 80. For improved compactness, integrability and portability, the laser source chosen could be either a pigtailed laser or fibre laser

After passing through a neutral density filter and a telescope (not shown) to optimize the coupling efficiency, the laser beam 80 is divided in two at a 50/50 beamsplitter 82. One beam is sent to a power meter 81 for stabilisation/calibration purposes, and the second beam is coupled to the lowest-order air-guided mode of the gas cell 2 using an objective lens 83. If the laser used is either a pigtailed or fibre laser, the objective lenses 83 may be omitted from the set-up. The light emerging from the gas cell 2 passes through a second objective lens 83 before being split into two beams. One is sent either to an optical spectrum analyzer 84 or to a fast photodetector 85 which monitor the total transmitted power. The other is sent to a set of calibrated fast photodetectors 86 in front of which are placed appropriate 10-nm bandpass colour filters 87 which separate out the pump, Stokes, and anti-Stokes signals. This setup allows rapid characterization of the generated Stokes and anti-Stokes signals as functions of pump power, interaction length, and gas pressure. In addition, the richness of the spectrum produced by this apparatus at low peak powers illustrates the extreme effectiveness of the invention in SRS devices, in a significantly less bulky configuration than that described in Benabid et al, with significantly lower power losses than that described in WO2006/077437.

The invention has further applications as part of a laser frequency measurement or stabilisation system. Accurate and stable laser frequencies are required for various applications, such as high-resolution spectroscopy, measurements of fundamental physical constants, atomic physics and quantum optics. Optical telecommunication is another field, which has an increasing need for wavelength accuracy and stability in order to enhance the number of channels in wavelength division multiplexing and demultiplexing (WDM) systems. Despite the progress made in reducing the line width of free running semiconductor laser systems such as extended cavity diode lasers (ECDL), problems such as long-term frequency instability and drift still remain. In order to ensure both accuracy and long-term frequency stability of free running lasers, the laser frequency is usually locked to an optical frequency reference. This consists of interacting a single-frequency laser with an ensemble of atoms or molecules that exhibits an absorption line suitable as a reference for frequency stabilisation. When the laser frequency is tuned across the resonance, a part of the power is transferred from the laser radiation to the absorber and an absorption feature is detected as a function of the laser frequency. The stabilisation circuit converts this absorption signal to an error signal, which is then used to hold the laser frequency at a given position of the absorption line. The performance of a reference line is determined by the stability and reproducibility of its reference frequency, which in turn is determined by (a) a high quality factor; Q=v/Δv, where v is the carrier frequency and Δv is the line width of the reference line (b) a weak dependence on external disturbances (e.g. temperature, strain and pressure). Furthermore, for absolute and reliable laser frequency stabilisation, a second and independent frequency standard is required. Up until now, such a system has been very complex and necessitates large amount of space.

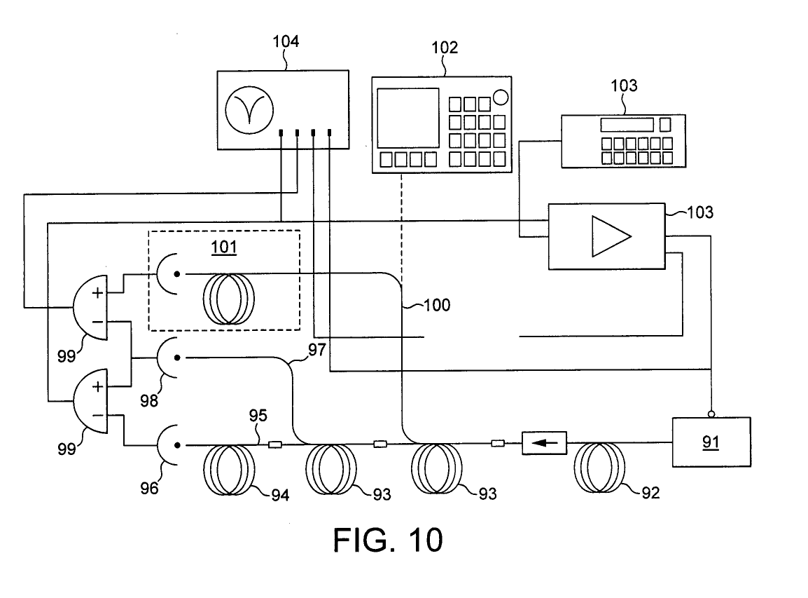

FIG. 10 shows the invention incorporated into a system for laser frequency locking. A laser beam from a commercial tunable ECDL 91 is coupled to an all-fibre system consisting of an isolator 92, two couplers 93 and an acetylene filled Hollow-Core Photonic Crystal Fibre (HC-PCF) 94 gas-cell of the type described above. After passing through the isolator 92, the laser output, is split by the two couplers 93 into three beams. A first locking beam 95 passes through the acetylene filled HC-PCF 94 and is then detected with a photodetector 96. A second reference beam 97 is detected with an identical detector 98. The signals of the locking 95 and the reference 97 beams pass through a difference amplifier 99, to reduce the effect of laser intensity fluctuations, before being fed to a locking circuit unit 103. Before locking, the wavelength of the laser is first tuned to the desired absorption line by adjusting the laser diffractive grating and the piezo-electric transducer (PZT) or any other appropriate corrector while observing the wavelength value on an optical spectrum analyzer 102 and monitoring operation using for example an oscilloscope 104 or RF spectrum analyser. The absolute stability of the laser frequency is then tested independently via a third, out-of loop beam 100, which is sent to an independent frequency discriminator 101 consisting of a second HC-PCF based acetylene cell. Thus the control and the monitoring of the laser stabilisation are carried out using a completely fibre based system.

The system in FIG. 10 can be successfully used to lock the laser frequency to different acetylene absorption lines. Acetylene is a useful choice of filling gas, as it offers an excellent frequency standards source for the optical communication wavelength; however it will be appreciated that the system could easily use a different frequency gas or atomic vapour such as Iodine, Rubidium or Carbon Dioxide, etc. It has also been demonstrated that use of HC-PCF in such a system has led to unprecedented improvement in signal-to-noise ratio, making overtone absorptions in the visible and near-infrared accessible to laser frequency metrology.

In a further approach, for low pressures, a buffer gas can be used.

In one preferred approach the buffer gas comprises for example helium, xenon or argon although it would be appreciated that any appropriate gas which is not reactive with the active gas inside the gas cell and which has high permeation through the material of the cladding 206 of the fibre, e.g. silica, can be selected. The active gas may comprise for example acetylene.

One possible implementation of this system lies in laser frequency stabilisation of the nature described above and in more detail below. In that case the active gas is preferably an atomic vapour at a very low pressure providing an extremely narrow spectral line. The active gas may be, for example obtained by metal vaporisation of rubidium. In that case the provision of a buffer gas in addition to allowing low pressure operation also protects against the highly reactive atomic vapour and permeates out to leave only the low pressure atomic vapour.

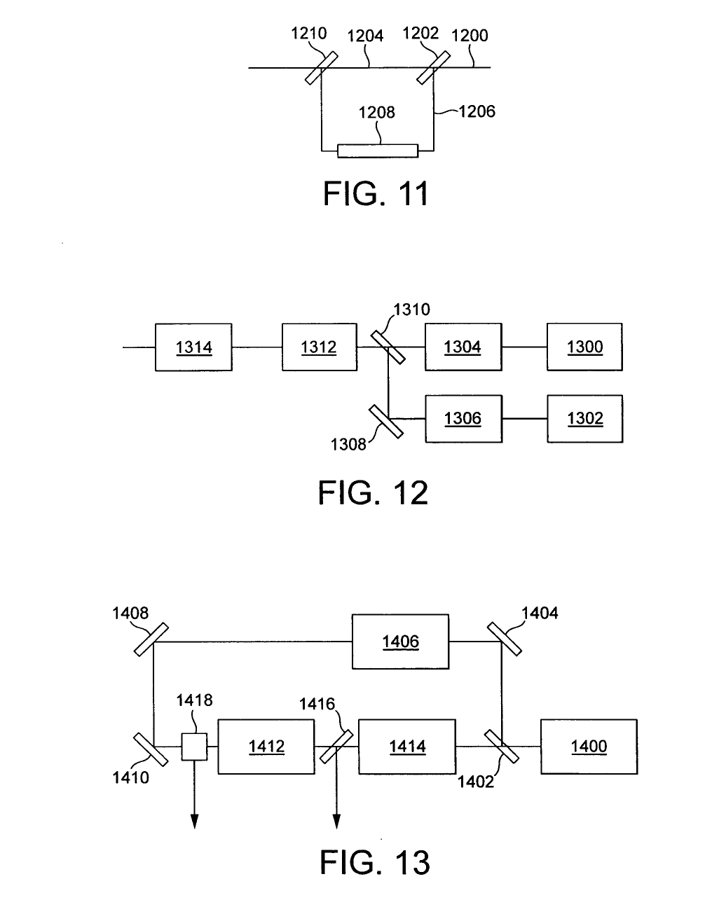

A further possible implementation of this arrangement can be further understood with reference to FIG. 11 shown allowing a delay to be introduced between optical branches using so called “slow light”. According to the system, input light 1200 is split for example by a half silvered mirror 1 into a non delayed component 1204 and a delayed component 1206. The delayed component is conveyed for example by a fibre optic channel to a gas cell of the type described above including an active gas at very low pressure, reference 1208. As is well known, using appropriate tuning the gas cell can effectively introduce a propagation delay into the light passing through it. The light is recombined for example at the further half silvered mirror 1210 and the effects of the delay between the delayed and un-delayed portion can then be monitored as appropriate.

In another possible implementation of such a low pressure configuration, electromagnetically induced transparency (EIT) can be achieved. EIT comprises an important development in quantum optics, but requiring very low pressure/high vacuum range values for the confined gas.

EIT comprises an effect in which a medium driven by a control laser, a probe laser whose frequency is close to an otherwise absorbing transition will experience a narrow window of transparency at the centre of the absorption profile. The effect is based on coherent population trapping in which a combination of two laser fields excites a three level system into a coherent super position state of the two lower energy states. In such a case the quantum system can simultaneously occupy both states in a phase-lock fashion and the two possible light pathways can interfere and cancel each other. The net result of this destructive quantum interference is that none of the atoms or molecules are promoted to the excited state, leading to vanishingly small optical absorption. In addition the transparency is accompanied with a very sharp change in dispersion. This effect is useable for example in ultra slow light, light storage, laser cooling, non-linear optics and atomic clocks.

An apparatus for providing EIT is shown in FIG. 12 and comprises a control laser 1300 and a probe laser 1302 which pass respective beams through first and second polarisers 1304, 1036. The beams are recombined via mirrors 1308, 1310 before passing through an acetylene-filled HC-PCF cell 1312. The beam then passes into a further polariser 1314 and out to any appropriate output.

The control beam is provided at approximately 500 mW by any appropriate commercial tuneable external cavity diode laser amplified for example by a 1 W erbium-doped fibre amplifier and is resonant with an absorption line P(J+1) in the P branch of the overtone band of acetylene. The probe laser 1302 delivers a probe beam of approximately 200 μW delivered by a second tuneable external cavity diode laser tuned around an absorption line either R(J+1) or R(J−1) in the R-branch. The respective beams are cross polarised by polariser 1304, 1306 and at the output of the HC-PCF 1312, the control beam is filtered out by polariser 1312 or another appropriate interference filter leaving the probe beam to be transmitted and detected. The transmission profile of the probe absorption line is generated by sweeping the frequency of the probe laser for example by driving a piezo-electric transducer, giving a span bandwidth of approximately 1 GHz. In the cell 1312, the fibre has a guidance band centred at 1550 nm and has a 20 μm core diameter. The choice of a larger core is motivated by the need to reduce the collision rate of the gas with the core wall reducing any sources of dicoherence. According to this approach EIT can be observed.

Referring to FIG. 13 it will be seen that saturable absorption can also be observed using a cell of the type described herein comprising an acetylene-filled HC-PCF. In this configuration both control and probe beams are delivered by an amplified external cavity diode laser of the type described above, reference numeral 1400. The laser 1400 is tuned around an absorption line of the acetylene overtone band. The beam is approximately 1 watt and split by a 50/50 splitter for example a half silvered mirror 1402 to provide two counter propagating beams through the gas cell. One beam is deflected to mirror 1404 and through a polariser 1406 and then enters the cell 1412 in the first direction. The undeviated beam passes through splitter 1402 and polariser 1414 into the other end of the gas cell. A further polariser and circulator 1416 is provided at the output end of the cell 1412 for the selected beam and a second circulator 1418 is provided at the output end of the gas cell 1412 for the undeviated beam. A probe signal output is received from the first component 1416 and a monitoring output from the second component 1418. As a result the polarisation of the counter propagating beams is controlled by the polarisers and provision of a circulator at both ends of the gas cell (1418, 1416) ensures that beams counter propagating through the cell 1412 cannot be detected at the output of the circulators and are not coupled back into the laser system.

It will be appreciated that the applications for which the invention may be used are not limited to those described above. It is proposed that such efficient gas filled fibres will enable compact devices such as atomic timers to be developed. The technology could also be used to enable the development of a variable continuous wave/modelocked pulsed femtosecond lasers, without restriction on the location of the central wavelength, as well as miniaturised laser colour-conversion devices.

The gas cell material is not limited to Hollow-Core Photonic Crystal Fibre; any suitable fibre or gas cell acting as a wave guide, in which an optical propagation cavity may be formed to provide 3-dimensional confinement, may be employed, such as the silicon Arrow waveguide

The optical fibre portion material is not restricted to single mode fibre, and may be replaced by a free space arrangement where appropriate. The arrangement may be integrated into a microchip. The gas cell may be filled with any suitable gas or gases by any appropriate means. The radiation propagated may be of any appropriate wavelength, not limited to visible light, and the terms “optical” and “light” are used in that broad sense throughout.

What is claimed is:

1. An optical fibre having a fibre cladding around a longitudinally extending optical propagation core, the cladding having a reflection region of a varying refractive index in the longitudinal direction, wherein the fibre is a hollow-core photonic crystal fibre (HCPCF).

2. An optical fibre as claimed in claim 1 in which the refractive index varies periodically in the reflection region.

3. An optical fibre as claimed in claim 1 or claim 2 wherein the reflection region comprises a Bragg grating.

4. An optical fibre as claimed in claim 1 wherein the core is substantially circular or triangular in cross section.

5. An optical fibre as claimed in claim 1 wherein the optical fibre includes a plurality of longitudinally extending optical propagation cores.

6. An optical fibre as claimed in claim 2 wherein the periodic change in refractive index is substantively sinusoidal.

7. An optical fibre as claimed in claim 1 wherein the material of the cladding is doped to provide said variation in refractive index.

8. An optical fibre as claimed in claim 1 wherein the cladding is embedded or coated with a material having a different refractive index to the cladding material in order to provide said variation in refractive index.

9. An optical fibre as claimed in claim 8 wherein a periodic index modulation is permanently inscribed into the embedded or coated material by application of an intense laser interference pattern.

10. (canceled)

11. An optical fibre as claimed in claim 1 wherein the hollow core comprises a gas cell.

12. An optical fibre as claimed in claim 11 wherein the gas cell contains at least one of a gas-phase material and a liquid-phase material.

13. An optical fibre as claimed in claim 11 wherein the cell contains any of Hydrogen, Acetylene, Iodine, Rubidium, Carbon Dioxide and Caesium.

14. (canceled)

15. An optical fibre as claimed in claim 1 wherein the cladding further comprises a second reflection region longitudinally spaced from the first reflection region, to define an optical confinement cavity therebetween.

16. An optical fibre as claimed in claim 15 wherein the optical confinement cavity defines a gas cell within the fibre.

17. A method of fabricating an optical fibre having a fibre cladding around a longitudinally extending optical propagation core, comprising forming a reflection region in the cladding having a varying refractive index in the longitudinal direction.

18. The method of claim 17 wherein the reflection region is defined by forming a Bragg grating in the cladding material.

19. The method of claim 17 or claim 18 wherein the cladding is formed from photorefractive material.

20. The method of claim 17 or claim 18 wherein the step of forming the reflection region comprises doping the cladding material.

21. The method of claim 18 wherein the step of forming a Bragg grating comprises coating or embedding the cladding material with a material having a different refractive index to the cladding material.

22. The method of claim 21 wherein the index of second material is modulated using at least one of: a laser technique, heat application and stress application.

23. The method of claim 17 wherein the optical fibre includes a plurality of longitudinal extending propagation cores.

24. The method of claim 17 wherein said core or at least one of said plurality of cores of the optical fibre is hollow.

25. The method of claim 24 further comprising the step of filling said hollow core or cores with gas, to form a gas cell or cells.

26. The method of claim 23 further comprising the step of filling said hollow core or cores with gas, to form a gas cell or cells and wherein a first one of said cores is filled with a first gas and a second one of said cores is filled with a second, different gas.

27. The method of any of claim 25 or claim 26 further comprising propagating optical radiation along the hollow core or cores.

28. A stimulated Raman scattering apparatus including an optical fibre as claimed in claim 1.

29. A method of carrying out stimulated Raman scattering using an optical fibre as claimed in claim 1.

30. A laser frequency stabilisation apparatus including an optical fibre as claimed in claim 1.

31. A method of performing laser frequency stabilisation using an optical fibre as claimed in claim 1.

32. A device including an optical fibre as claimed in claim 1, wherein the device comprises one or more of the group including an atomic timer, a continuous wave/modelocked pulsed femtosecond laser, and a laser colour conversion device.

33. A laser frequency stabilisation device including a control path and a reference path in which the control path includes a control cell comprising an optical fibre as claimed in claim 11, wherein the hollow core of the optical fibre is arranged to act as a waveguide.

34. An optical delay component including an optical fibre as claimed in claim 1.

35. An optical delay circuit including an input beam generator and an input beam splitter splitting part of the input beam to a delaying channel from which it is recombined with the remainder of input beam, in which the delaying channel includes an optical delay component as claimed in claim 34.

36. An electromagnetically induced transparency component including an optical fibre as claimed in claim 1.

37. An electromagnetically induced transparency circuit comprising a control beam generator and a probe beam generator and a beam combiner for combining the beam into a component as claimed in claim 34.

38. A saturable absorption component including an optical fibre as claimed in claim 1.

39. A saturable absorption circuit including a saturable absorption component as claimed in claim 36.

40. A method as claimed in claim 25 in which the core or cores are filled with a sample gas and a buffer gas.

41. A method as claimed in claim 40 in which the buffer gas is permeable through a wall of the gas cell, or cells.

42. A method as claimed in claim 40 or claim 41 in which the buffer gas comprises one of helium, xenon, or argon.

43. A method as claimed in claim 40 or 41 in which the sample gas comprises an atomic vapour.

44. A method of designing an optical fibre having a longitudinally extending optical propagation core surrounded by a fibre cladding, the cladding having a reflection region of a varying refractive index in the longitudinal direction, the method comprising the step of designing the shape of the core to maximise, in use, the overlap between optical radiation propagated along the core and the material of the cladding.

45. A gas sensor including an optical fibre as claimed in claim 1.

46. An optical arrangement including a first optical fibre having a longitudinally extending optical propagation core and a second optical fibre having a longitudinal reflection region of varying refractive index wherein said first and second optical fibres are arranged such that, in use, at least a portion of an incident light mode guided into said first optical fibre overlaps with at least a portion of the reflection region in said second fibre.

47. An optical arrangement as claimed in claim 46 wherein the second fibre further includes an optical propagation core.
